(19) United States
(12) Patent Application Publication
(10) Pub. No.: US 2013/0181988 A1
(43) Pub. Date: Jul. 18, 2013

(54) APPARATUS AND METHOD FOR CREATING POSE CLUSTER

(71) Applicant: Samsung Electronics Co., Ltd., Suwon-si (KR)

(72) Inventors: Byung In YOO, Seoul (KR); Chang Kyu CHOI, Sungnam-si (KR); Hee Seob RYU, Hwasung-si (KR); Chang Kyo LEE, Yongin-si (KR); Jae Joon HAN, Seoul (KR)

(73) Assignee: Samsung Electronics Co., Ltd., Suwon-si (KR)

(21) Appl. No.: 13/738,509

(22) Filed: Jan. 10, 2013

(30) Foreign Application Priority Data
Jan. 16, 2012 (KR) 10-2012-0004653

(51) Int. Cl. G06T 17/00

(52) U.S. Cl. CPC G06T 17/00
USPC 345/420

(57) ABSTRACT

Provided is a method of creating a body pose cluster, including performing feature extraction from pose data about at least one pose, classifying, as a single cluster, similar poses from a feature vector space using a similarity measure, and configuring the number of poses included in each cluster from the feature vector space to be uniform using an imbalance measure.

### CROSS-REFERENCE TO RELATED APPLICATIONS

This application claims the priority benefit of Korean Patent Application No. 10-2012-0004653, filed on Jan. 16, 2012, in the Korean Intellectual Property Office, the disclosure of which is incorporated herein by reference.

### BACKGROUND

1. Field

Embodiments relate to an apparatus and method that may define a pose as a multi- dimensional vector and may adjust pose vectors to be uniformly distributed on a multi- dimensional space instead of being densely distributed.

2. Description of the Related Art

In a daily life, a human uses two eyes and thus, is capable of well recognizing even a human body pose positioned in a long distance and having a low resolution.

Even though a method of recognizing a human body pose in a computer vision system is required in various fields, it is still difficult to accurately recognize a body pose.

In general, a method of erasing overlapping poses from motion captured poses based on a distance between joints may be used as a method of creating a body pose cluster. Here, a pose of which motion is not captured in advance may not be included.

Generally, in many poses of a user, the user may be mostly standing with waving a hand. Therefore, while a lower body of the user is configured to be the same, an upper body of the user may be configured to have various poses.

Accordingly, in a body pose cluster, pose vectors need to be uniformly distributed instead of being densely distributed.

### SUMMARY

In an aspect of one or more embodiments, there is provided an apparatus for creating a body pose cluster, the apparatus including a data receiver to receive pose data about at least one pose, a feature extractor to extract a feature vector from the pose data, a cluster classifier to classify, as a single cluster, similar poses from a feature vector space using a similarity measure, a cluster adjustment unit to configure the number of poses included in each cluster from the feature vector space to be uniform using an imbalance measure, and a pose cluster creator to create a pose cluster by adjusting each cluster to have a predetermined pose density.

The pose data may include motion capture data or image data that is created by retargeting the motion capture data through a three-dimensional (3D) graphical model.

The feature extractor may perform a feature extraction using at least one of a hue moment, a Legendre moment, and a level set.

The cluster classifier may include a feature vector detector to detect a feature vector of a current pose extracted through feature extraction, a cluster search unit to search a cluster having a similarity with the feature vector, a first pose assignment unit to assign the current pose to the cluster when the cluster having the similarity is present, and a second pose assignment unit to create a new cluster and assign the current pose to the new cluster when the cluster having the similarity is absent. The cluster classifier may complete clustering by repeating each module operation.

The cluster classifier may include a cluster detector to detect each cluster, a determining unit to determine whether a number of pose data within each cluster is greater than a threshold, and a cluster splitter to split each cluster into at least two portions when the number of pose data within each cluster is greater than the threshold. The cluster classifier may complete clustering by repeating each module operation.

The cluster classifier may include an average pose calculator to calculate the average pose feature vector of each cluster, a pose sorting unit to sort at least one pose based on an inter-pose similarity from the average pose feature vector, a similarity calculator to calculate a similarity between a current pose and a subsequent pose, a pose adder to add another pose to each cluster when the similarity between the current pose and the subsequent pose is greater than a predetermined maximum threshold, a pose eraser to erase poses within each cluster when the similarity between the current pose and the subsequent pose is less than a predetermined minimum threshold, and a pose determining unit to determine a pose within each cluster when the similarity between the current pose and the subsequent pose is less than or equal to the predetermined maximum threshold and is greater than or equal to the predetermined minimum threshold. The cluster classifier may complete clustering by repeating each module operation.

The pose adder may include a reference pose setting unit to set a reference pose, a parameter setting unit to set at least one parameter for adding the other pose, and a new pose adder to add a new pose different from the reference pose based on the at least one parameter.

The cluster adjustment unit may include a reference cluster selector to select a reference cluster, a first reference pose calculator to calculate a first reference pose that is a reference among poses of the reference cluster, a neighbor cluster selector to select a neighbor cluster, a second reference pose calculator to calculate a second reference pose that is a reference among poses of the neighbor cluster, and a pose adder to add another pose to the reference cluster when a similarity between the first reference pose and the second reference pose is greater than a predetermined maximum threshold. The cluster adjustment unit may configure the number of poses included in each cluster to be uniform by repeating each module operation.

In accordance with an aspect of one or more embodiments, there is provided a method of creating a body pose cluster, the method including receiving pose data about at least one pose, performing feature extraction including a multi-dimensional vector for pose clustering from the pose data, classifying, as a single cluster, similar poses from a feature vector space using a similarity measure, configuring the number of poses included in each cluster from the feature vector space to be uniform using an imbalance measure, and creating a pose cluster by adjusting each cluster to have a predetermined pose density.

In an aspect of one or more embodiments, there is an apparatus for creating a pose cluster, the apparatus including a cluster classifier to classify, as a single cluster, similar poses from a feature vector space using a similarity measurement; a cluster adjustment unit adjuster, using at least one processor, to configure the number of poses included in each cluster from the feature vector space to be uniform using an imbalance measurement; and a pose cluster creator to create the pose cluster by adjusting each cluster to have a predetermined pose density.

In an aspect of one or more embodiments, there is a method of creating a pose cluster, the method including classifying, as a single cluster, similar poses from a feature vector space using a similarity measurement; configuring, using at least one processor, the number of poses included in each cluster from the feature vector space to be uniform using an imbalance measurement; and creating the pose cluster by adjusting each cluster to have a predetermined pose density.

According to another aspect of one or more embodiments, there is provided at least one computer readable medium storing computer readable instructions to implement embodiments of methods.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a configuration of an apparatus for creating a body pose cluster according to an embodiment;

FIG. 2 illustrates a method of creating a body pose cluster according to an embodiment;

FIG. 3 illustrates a method of clustering pose data according to an embodiment;

FIG. 4 illustrates a method of clustering pose data according to another embodiment;

FIG. 5 illustrates a method of forming a pose within a pose cluster based on a uniform vector distance according to an embodiment;

FIG. 6 illustrates a pose resampling method according to an embodiment;

FIG. 7 illustrates an example of a reference pose according to an embodiment;

FIG. 8 through FIG. 12 illustrate examples of a new pose created based on a pose resampling parameter according to an embodiment;

FIG. 13 illustrates a method of securing a pose uniformity between clusters according to an embodiment; and

FIG. 14 illustrates an example of a pose cluster according to an embodiment.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

When it is determined detailed description related to a related known function or configuration they may make embodiments unnecessarily ambiguous in describing embodiments, the detailed description will be omitted here. Also, terms used herein are defined to appropriately describe embodiments and thus, may be changed depending on a user, the intent of an operator, or a custom. Accordingly, the terms must be defined based on the following overall description of this specification.

An apparatus for creating a body pose cluster according to an embodiment may define a pose as a multi-dimensional vector and may adjust pose vectors to be uniformly distributed on a multi-dimensional space instead of being densely distributed.

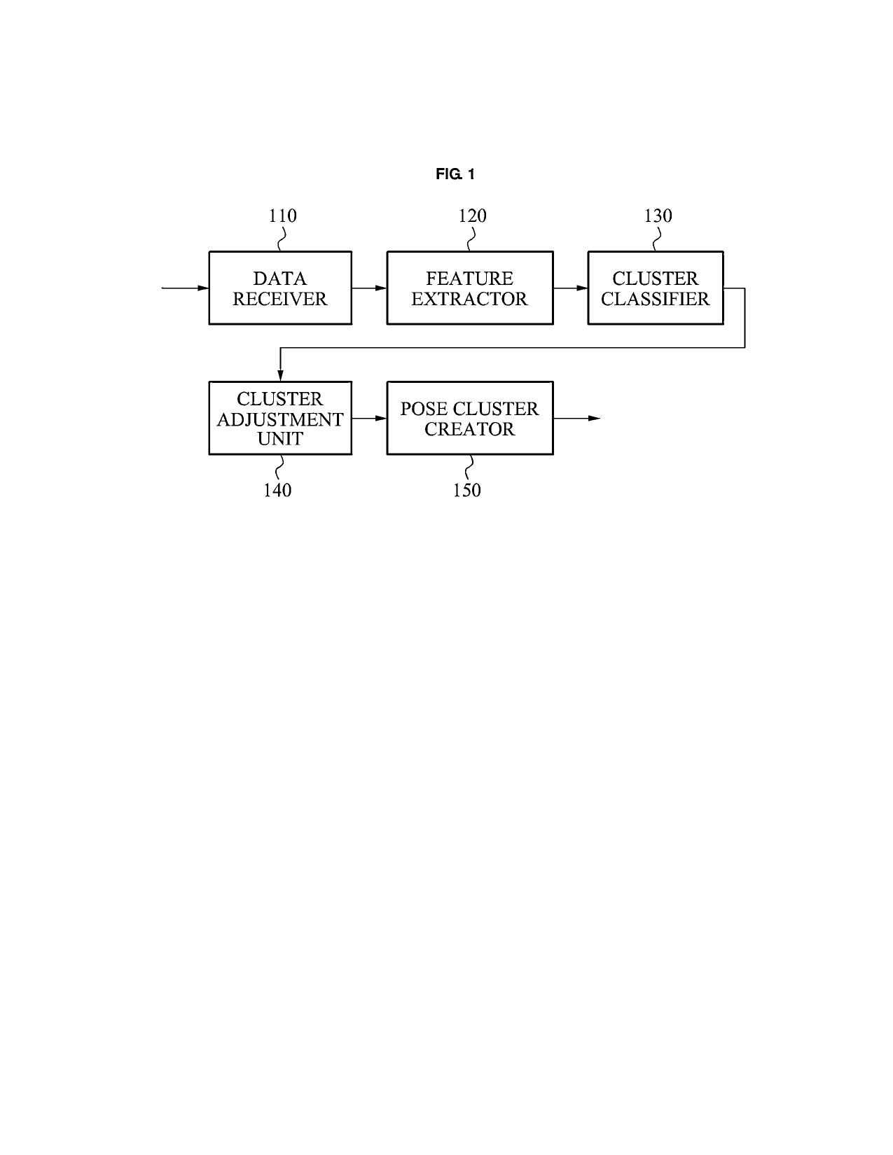

FIG. 1 illustrates a configuration of an apparatus for creating a body pose cluster according to an embodiment.

Referring to FIG. 1, the body pose cluster creating apparatus may include a data receiver 110 to receive pose data about at least one pose, a feature extractor 120 to extract a feature vector from the pose data, a cluster classifier 130 to classify, as a single cluster, similar poses from a feature vector space using a similarity measure (similarity measurement), a cluster adjustment unit (cluster adjuster) 140 to configure the number of poses included in each cluster from the feature vector space to be uniform using an imbalance measure (imbalance measurement), and a pose cluster creator 150 to create a pose cluster by adjusting each cluster to have a predetermined pose density.

Hereinafter, a method of creating a body pose cluster using the body pose cluster creating apparatus of FIG. 1 will be described. For ease of understanding, constituent elements of FIG. 1 may be employed throughout the specification.

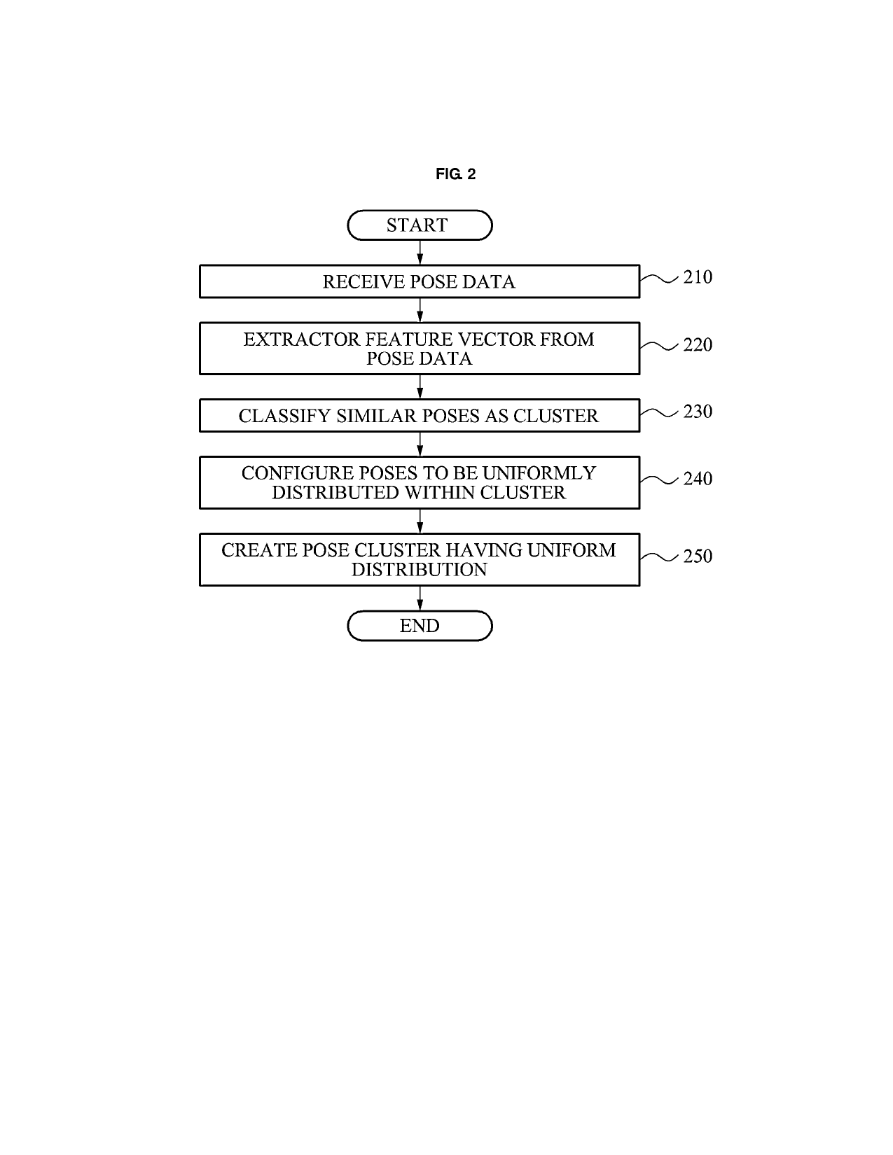

FIG. 2 illustrates a method of creating a body pose cluster according to an embodiment.

In operation 210, the body pose cluster creating apparatus may receive pose data about at least one pose.

In operation 220, the body pose cluster creating apparatus may extract a feature vector from the pose data.

For example, the body pose cluster creating apparatus may perform feature extraction including a multi-dimensional vector for pose clustering from the pose data.

In operation 230, the body pose cluster creating apparatus may classify, as a single cluster, similar poses from a feature vector space using a similarity measure.

In operation 240, the body pose cluster creating apparatus may configure the number of poses included in each cluster from the feature vector space to be uniform using an imbalance measure.

In operation 250, the body pose cluster creating apparatus may create a pose cluster by adjusting each cluster to have a predetermined pose density.

For example, when pose data clustering is completed, the body pose cluster creating apparatus may erase poses so that each cluster may have a uniform pose density, or may create a pose cluster having the uniform distribution by creating new poses.

According to an aspect, pose data about at least one pose may include various types of data such as motion capture data or image data that is created by retargeting the motion capture data through a three-dimensional (3D) graphical model.

According to an aspect, the feature extractor 120 may perform feature extraction by employing various feature extraction methods such as a hue moment, a Legendre moment, and a level set, for example. However, it is only an example and embodiments are not limited thereto.

For example, the body pose cluster creating apparatus may employ a hue moment feature extraction method to perform feature extraction robust against a position translation of a pose, a change in a scale, and a rotation.

The hue moment feature extraction method may include a liner combination of central moments, and may minimize a change in a moment value by linearly combining various types of central moments.

For example, in the case of a pose unidentifiable using a hue moment, feature extraction may be performed using a Legendre moment in which an orthogonal property clearly identifiable in a vector space is added, and the like.

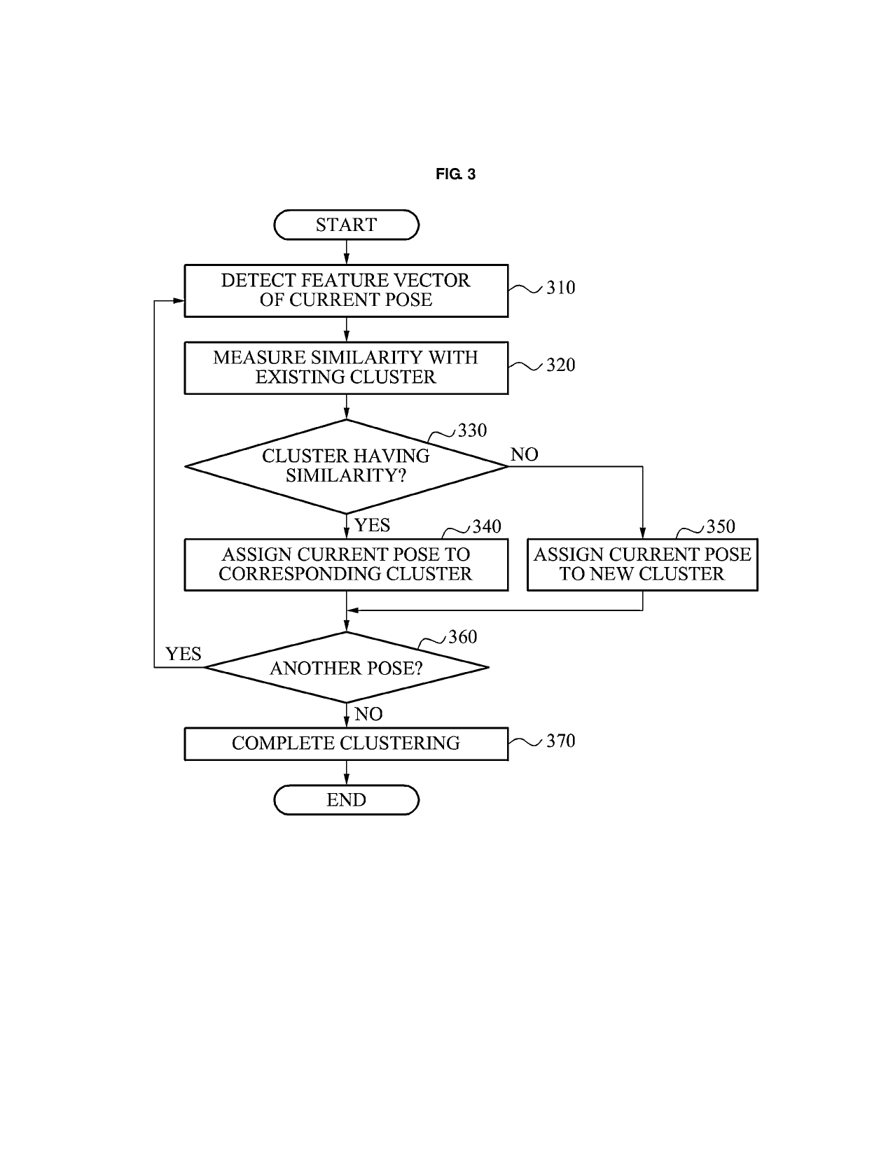

FIG. 3 illustrates a method of clustering pose data according to an embodiment.

Referring to FIG. 3, in operation 310, the cluster classifier 130 may detect a feature vector of a current pose extracted through feature extraction, using a feature vector detector.

In operation 320, the cluster classifier 130 may measure a similarity with an existing cluster.

In operation 330, the cluster classifier 130 may search a cluster having a similarity with the feature vector using a cluster search unit (cluster searcher).

For example, the cluster classifier 130 may receive a feature vector of a current pose to be clustered and search a cluster having a high similarity with the feature vector.

In operation 340, when the cluster having the similarity is present, the cluster classifier 130 may assign the current pose to the cluster using a first pose assignment unit (first pose assignor).

Conversely, when the cluster having the similarity is absent, the cluster classifier 130 may create a new cluster and assign the current pose to the new cluster using a second pose assignment unit (second pose assignor) in operation 350.

In operation 360, the cluster classifier 130 may determine whether there is another pose to be classified as a cluster. When there is another pose to be classified as a cluster, the cluster classifier 130 may repeat the above each module operation. When there is no other pose to be classified as a cluster, the cluster classifier 130 may complete the clustering in operation 370.

For example, when there is the cluster having the high similarity, the cluster classifier 130 may assign the current pose to the corresponding cluster. Conversely, when there is no cluster having the high similarity, the cluster classifier 130 may create a new cluster and assign the current pose to the corresponding new cluster.

According to an aspect, by repeating operations 310 through 370 with respect to all of the pose data, the cluster classifier 130 may complete clustering.

A measurement method for similarity comparison according to an aspect may employ a Euclidean distance scheme, a cosine similarity scheme, and the like.

Assuming that a feature extracted from current pose data is u and the average feature vector of a predetermined cluster is v, when a feature vector has a dimension of “N”, the Euclidean distance scheme may be applied as follows.

In this example, as a result value, that is, d_{E} obtained by applying the Euclidean distance scheme according to Equation 1 becomes closer to zero, the current pose may be determined to belong to a predetermined cluster.

$${d}_{E} ( u , v ) = \vert u - v \vert = {[ {\sum }_{k = 1}^{N} {( {u}_{k} - {v}_{k} )}^{2} ]}^{1 / 2} \qquad [ Equation 1 ]$$

Alternatively, the cosine similarity scheme may be applied according to Equation 2. In this example, as a result value d_{C} becomes closer to “1”, the current pose may be determined to belong to a predetermined cluster. As the result value d_{C} becomes closer to “−1”, the current pose may be determined to not belong to a predetermined cluster.

$${d}_{C} ( u , v ) = cos ( θ ) = \frac{u \cdot v}{‖ u ‖ ‖ v ‖} = \frac{{\sum }_{k = 1}^{N} {u}_{k} \times {v}_{k}}{{\sum }_{k = 1}^{N} {( {u}_{k} )}^{2} \times {\sum }_{k = 1}^{N} {( {v}_{k} )}^{2}} \qquad [ Equation 2 ]$$

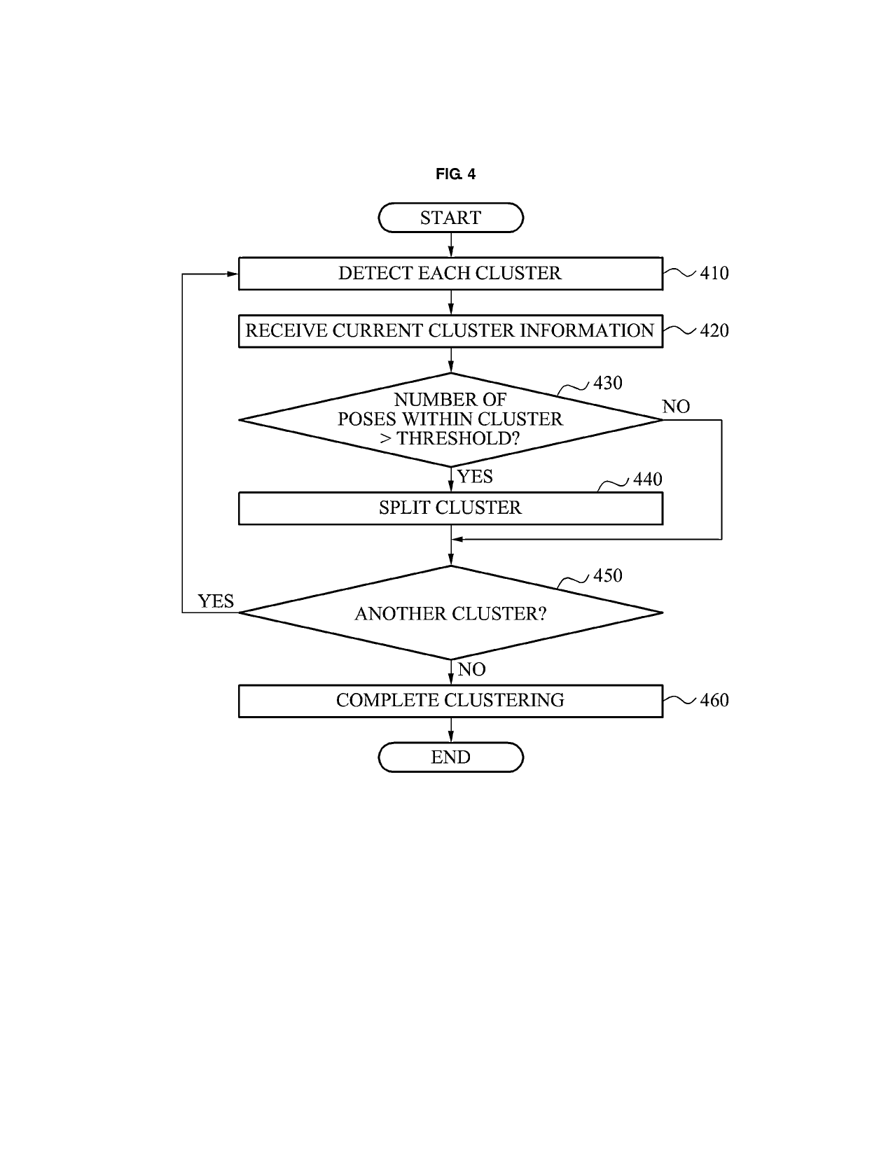

FIG. 4 illustrates a method of clustering pose data according to another embodiment.

Referring to FIG. 4, in operation 410, the cluster classifier 130 may detect each cluster using a cluster detector.

For example, the cluster classifier 130 may perform pose clustering using a similarity and the like.

In operation 420, the cluster classifier 130 may receive current cluster information.

In operation 430, the cluster classifier 130 may determine whether a number of pose data within each cluster is greater than a threshold using a determining unit (determiner).

When the number of pose data within each cluster is greater than the threshold, the cluster classifier 130 may split each cluster into at least two portions using a cluster splitter in operation 440.

In operation 450, the cluster classifier 130 may determine whether there is another cluster. When there is another cluster, the cluster classifier 130 may repeat each module operation. On the contrary, when there is no other cluster, the cluster classifier 130 may complete the clustering in operation 460.

According to an aspect, to uniformly configure the number of pose data within a cluster, the number of poses between clusters may be maintained to be similar using Equation 3.

B=|log|S₁|−log|S₂||

In Equation 3, each of S1 and S2 denotes the number of poses within an individual cluster. When B is minimized, it is possible to balance between two clusters.

According to an aspect, when the number of poses within a current cluster is greater than the number of predetermined poses, it is possible to configure the number of poses within each individual cluster to not exceed the number of predetermined poses by splitting the cluster into a plurality of clusters.

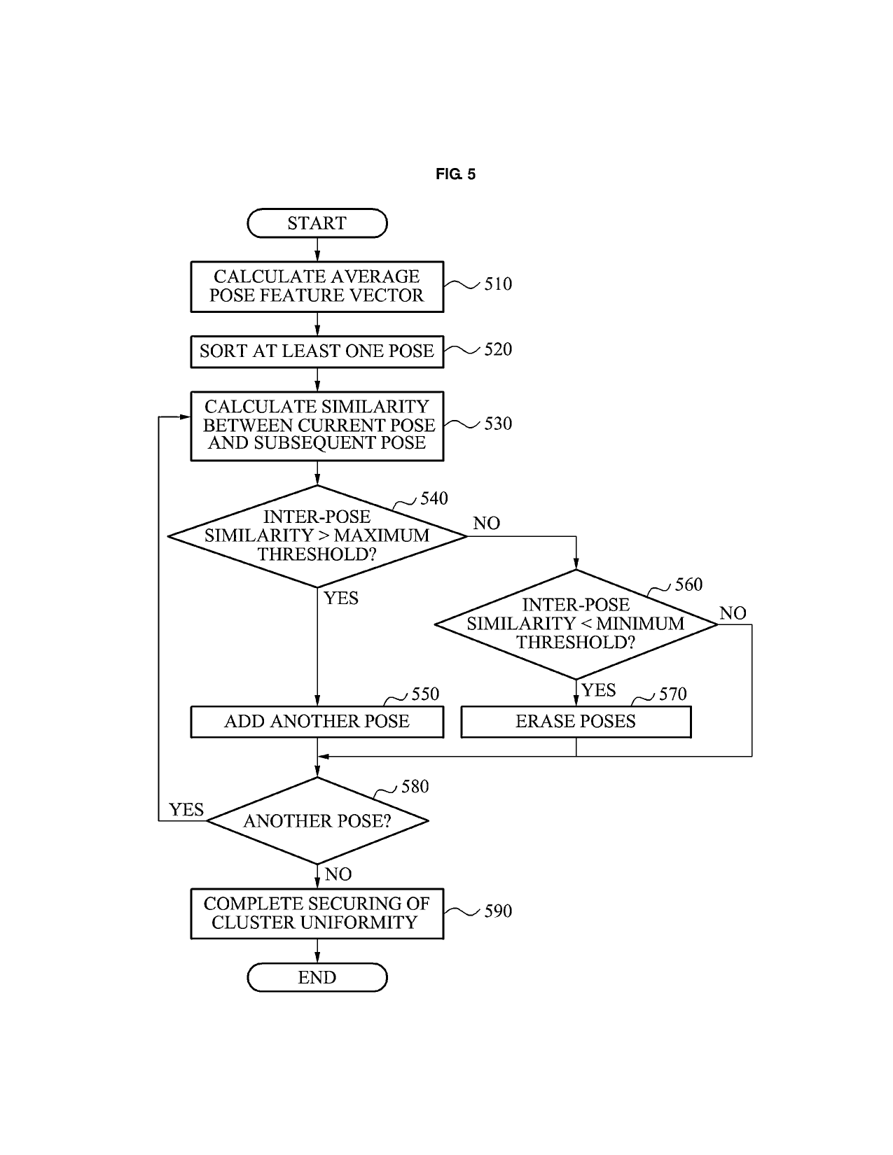

FIG. 5 illustrates a method of forming a pose within a pose cluster based on a uniform vector distance according to an embodiment.

Referring to FIG. 5, in operation 510, the cluster classifier 130 may calculate the average pose feature vector of each cluster using an average pose calculator.

According to an aspect, the cluster classifier 130 may calculate the average pose feature vector of a cluster. When it is assumed that a total number of poses within a cluster is P and a feature vector of an individual pose is Un, the average pose feature vector T may be expressed by Equation 4.

$$τ = \frac{1}{P} {\sum }_{n = 1}^{P} {u}_{n} \qquad [ Equation 4 ]$$

In operation 520, the cluster classifier 130 may sort at least one pose based on an inter-pose similarity from the average pose feature vector using a pose sorting unit (pose sorter).

A pose sorting method according to Equation 5 may be applied.

$${K}^{′} = {sort}_{v ∈ K} ( {d}_{c} ( τ , v ) ) \qquad [ Equation 5 ]$$

In Equation 5, K denotes a cluster including a plurality of poses, v denotes a feature vector of a pose belonging to K, and K′ denotes a new cluster in which the plurality of poses is sorted based on a difference with the average pose feature vector τ.

In operation 530, the cluster classifier may calculate a similarity between a current pose and a subsequent pose using a similarity calculator.

In operation 540, the cluster classifier 130 may determine whether the similarity between the current pose and the subsequent pose is greater than a predetermined maximum threshold.

When the similarity between the current pose and the subsequent pose is greater than the predetermined maximum threshold, the cluster classifier 130 may add another pose to each cluster using a pose adder in operation 550.

For example, when a distance between poses in K′ is greater than the maximum threshold, the cluster classifier 130 may add another pose through pose resampling.

In operation 560, the cluster classifier 130 may determine whether the similarity between the current pose and the subsequent pose is less than a predetermined minimum threshold.

When the similarity between the current pose and the subsequent pose is less than the predetermined minimum threshold, the cluster classifier 130 may erase poses within each cluster using a pose eraser in operation 570.

For example, when the similarity between the current pose and the subsequent pose is less than the maximum threshold and is less than the minimum threshold, the cluster classifier 130 may erase a corresponding pose from a cluster by performing pose weeding.

According to an aspect, when the similarity between the current pose and the subsequent pose is less than or equal to the maximum threshold and is greater than or equal to the minimum threshold, the cluster classifier 130 may determine a pose within each cluster using a pose determining unit (pose determiner).

In operation 580, the cluster classifier 130 may determine whether there is another cluster. When there is another cluster, the cluster classifier 130 may repeat each module operation. On the contrary, when there is no other cluster, the cluster classifier 130 may complete securing of cluster uniformity in operation 590.

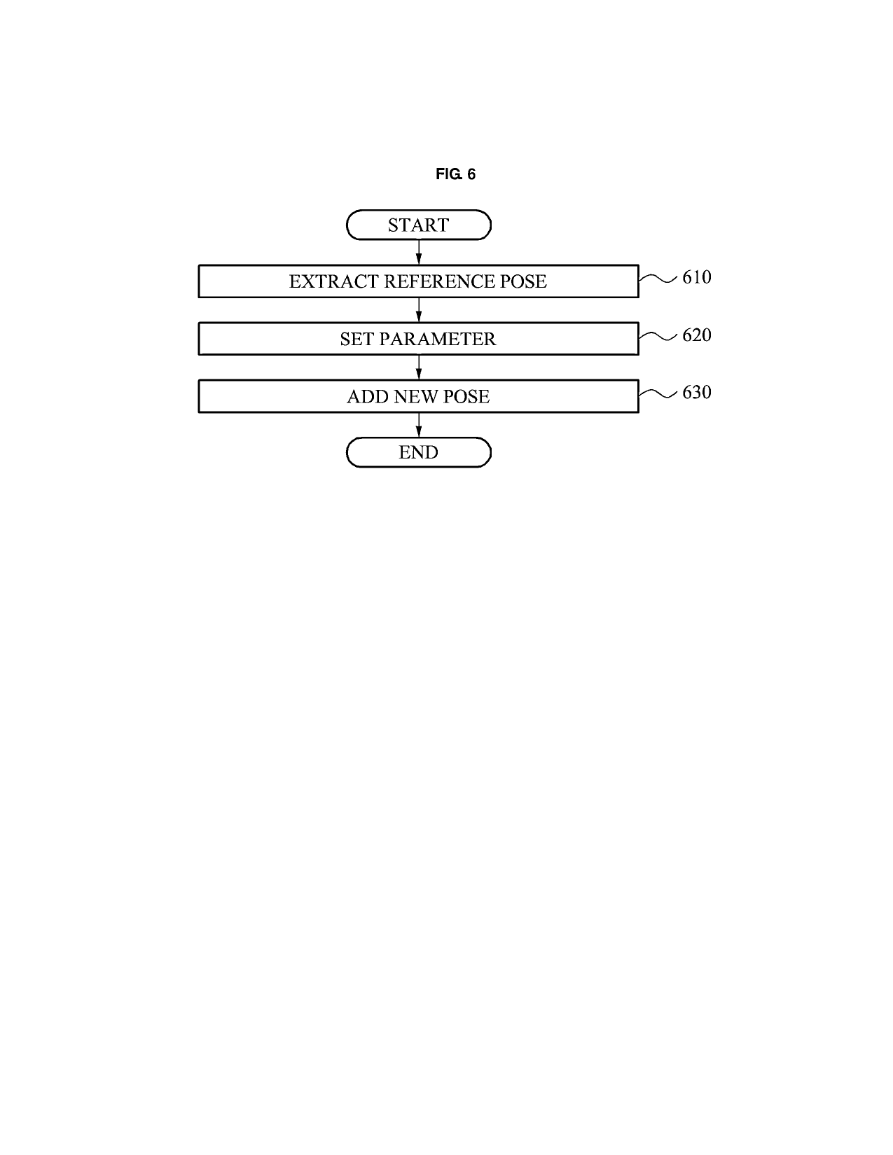

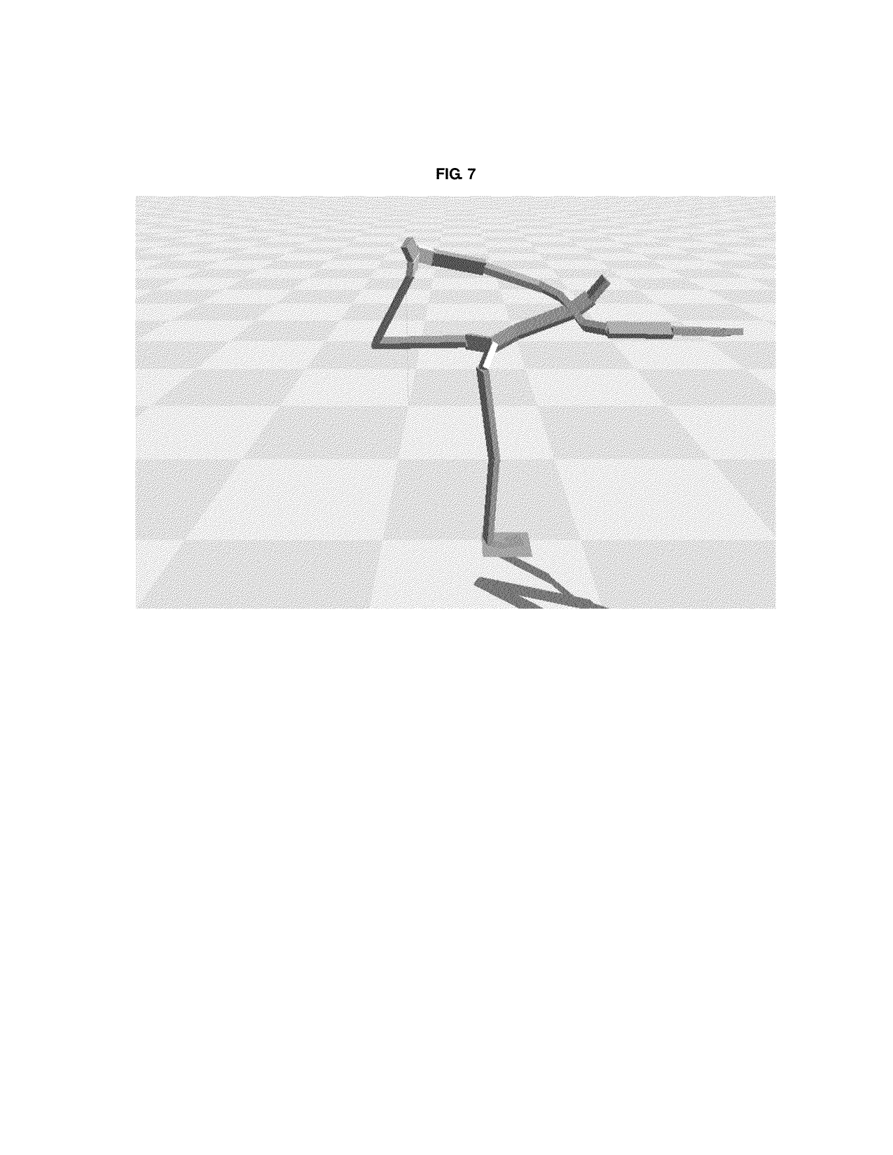

FIG. 6 illustrates a pose resampling method according to an embodiment, and FIG. 7 illustrates an example of a reference pose according to an embodiment.

Referring to FIG. 6, in operation 610, the pose adder may add a reference pose using a reference pose setting unit (reference pose setter) as shown in FIG. 7.

In operation 620, the pose adder may set at least one parameter for setting the other pose using a parameter setting unit (parameter setter).

A parameter settable by the parameter setting unit may be variously modified.

As one example, a parameter may be a root translate and may make a modification of adjusting the height of pelvis.

As another example, a parameter may be a root rotate and may make a modification of vertically rotating a body based on a predetermined axis.

As still another example, a parameter may be a left-arm rotate and may make a modification of vertically moving a left arm based on a predetermined axis.

As yet another example, a parameter may be a right-arm rotate and may make a modification of vertically moving a right arm based on a predetermined axis.

As still another example, a parameter may be a left-foot rotate and may make a modification of making a left foot become closer to or away from the center of a body while touching on the ground.

As still another example, a parameter may be a right-foot rotate and may make a modification of making a right foot become closer to or away from the center of a body while touching on the ground.

According to an aspect, a connection difference between a reference pose and a subsequence pose may be a change range of a pose resampling parameter.

In operation 630, the pose adder may add a new pose different from the reference pose based on the at least one parameter using a new pose adder.

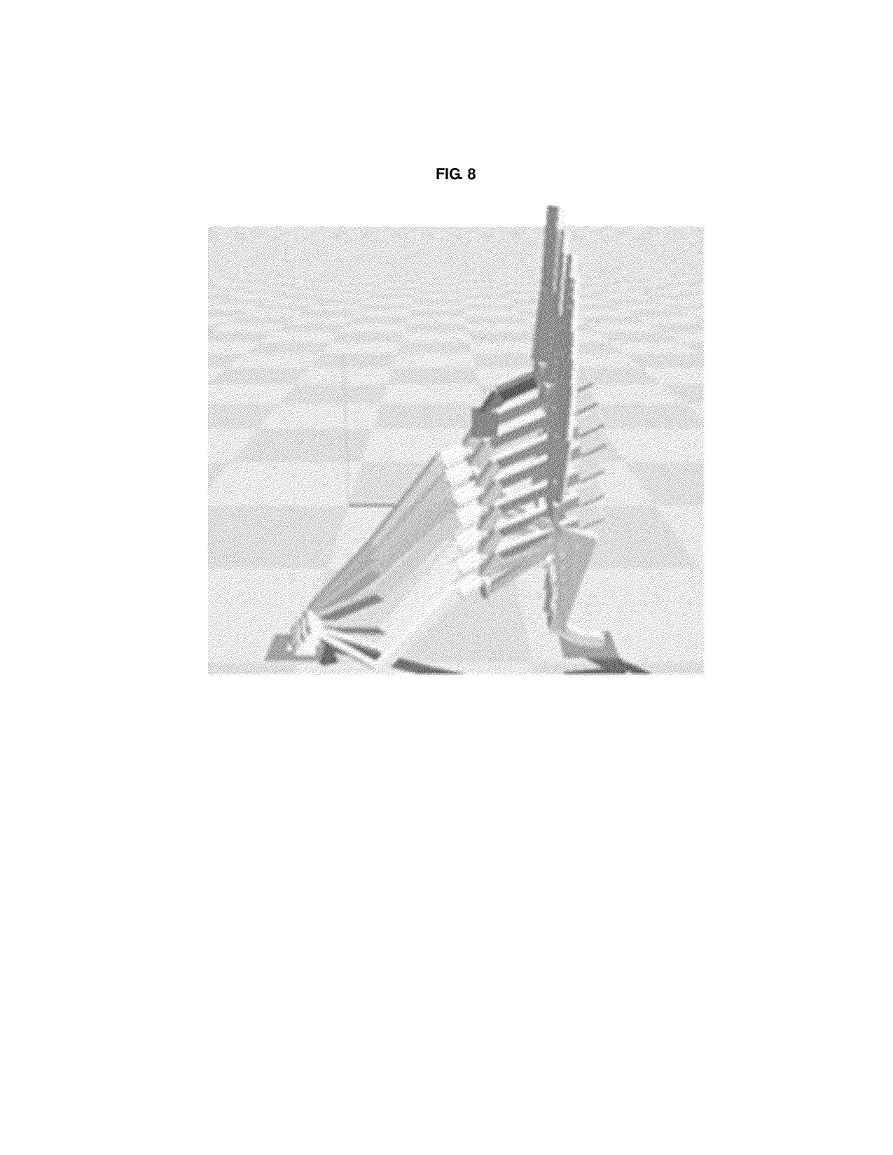

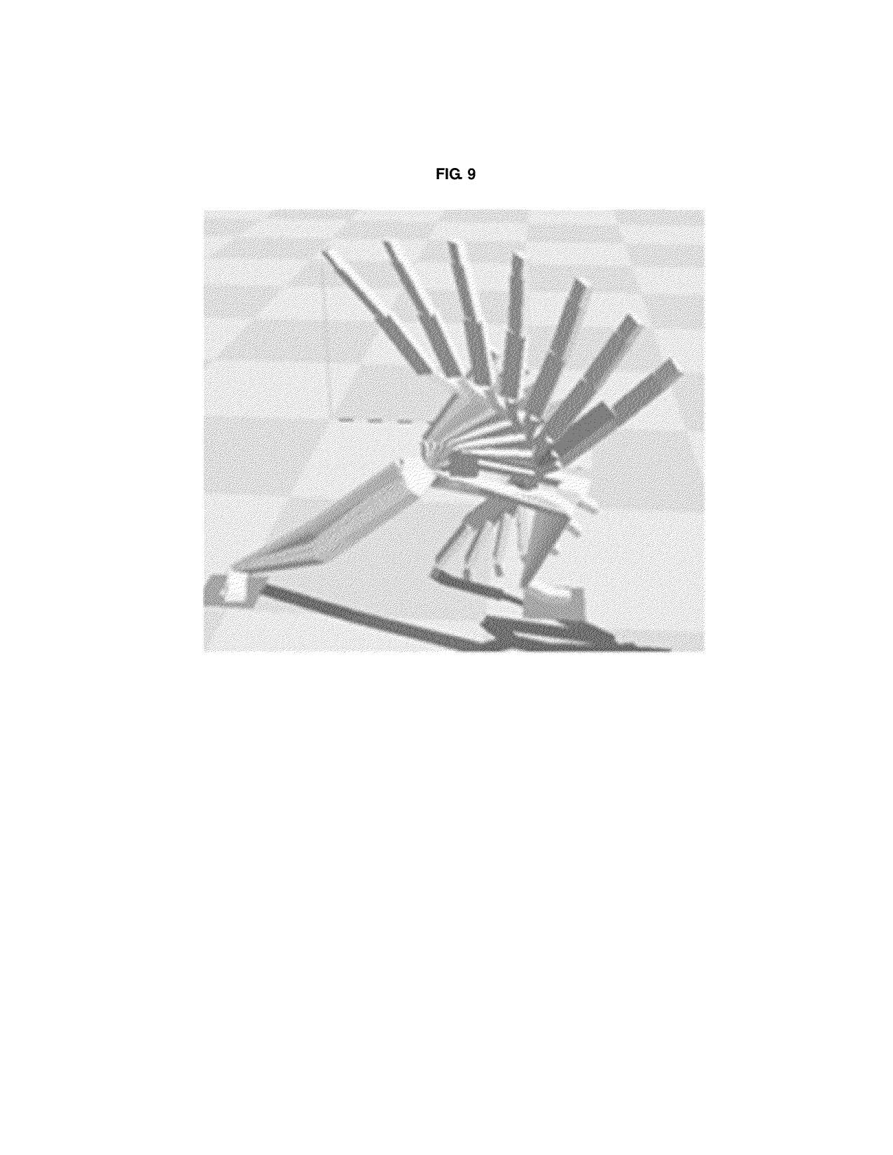

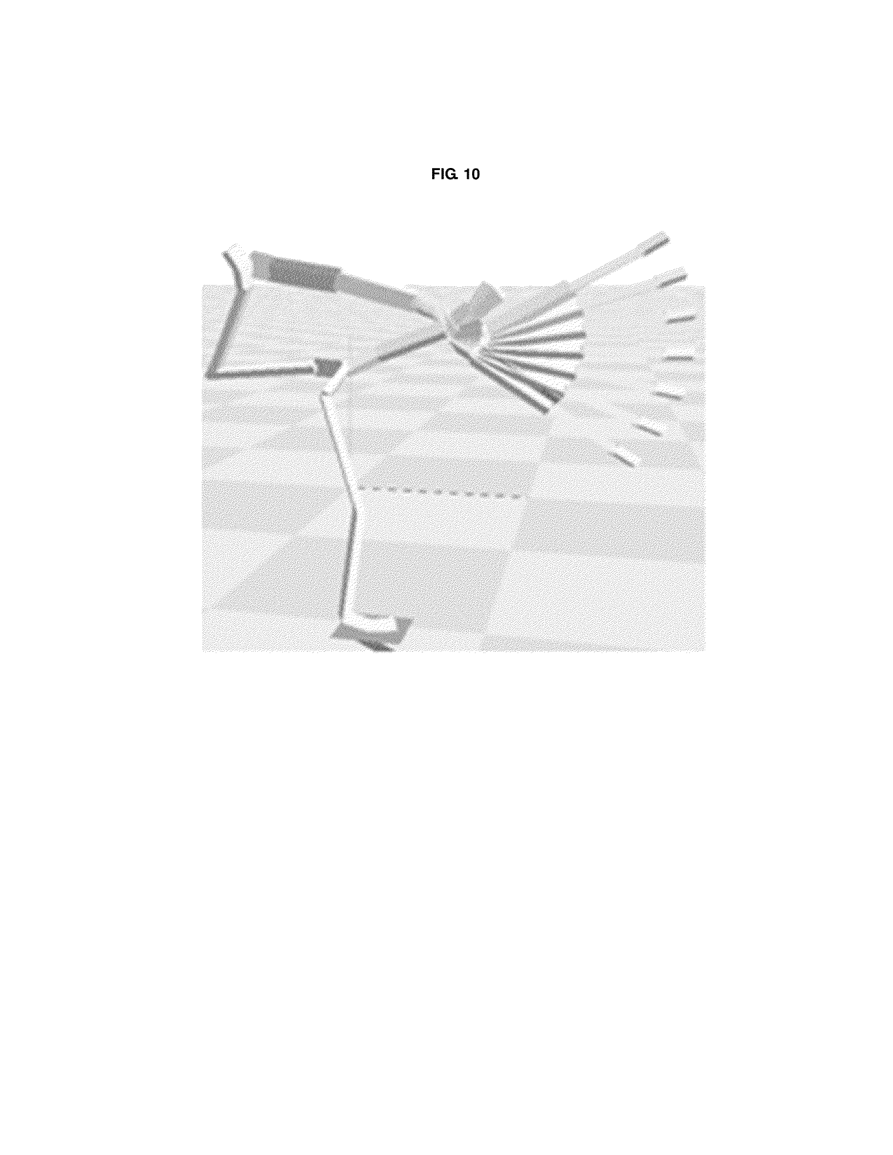

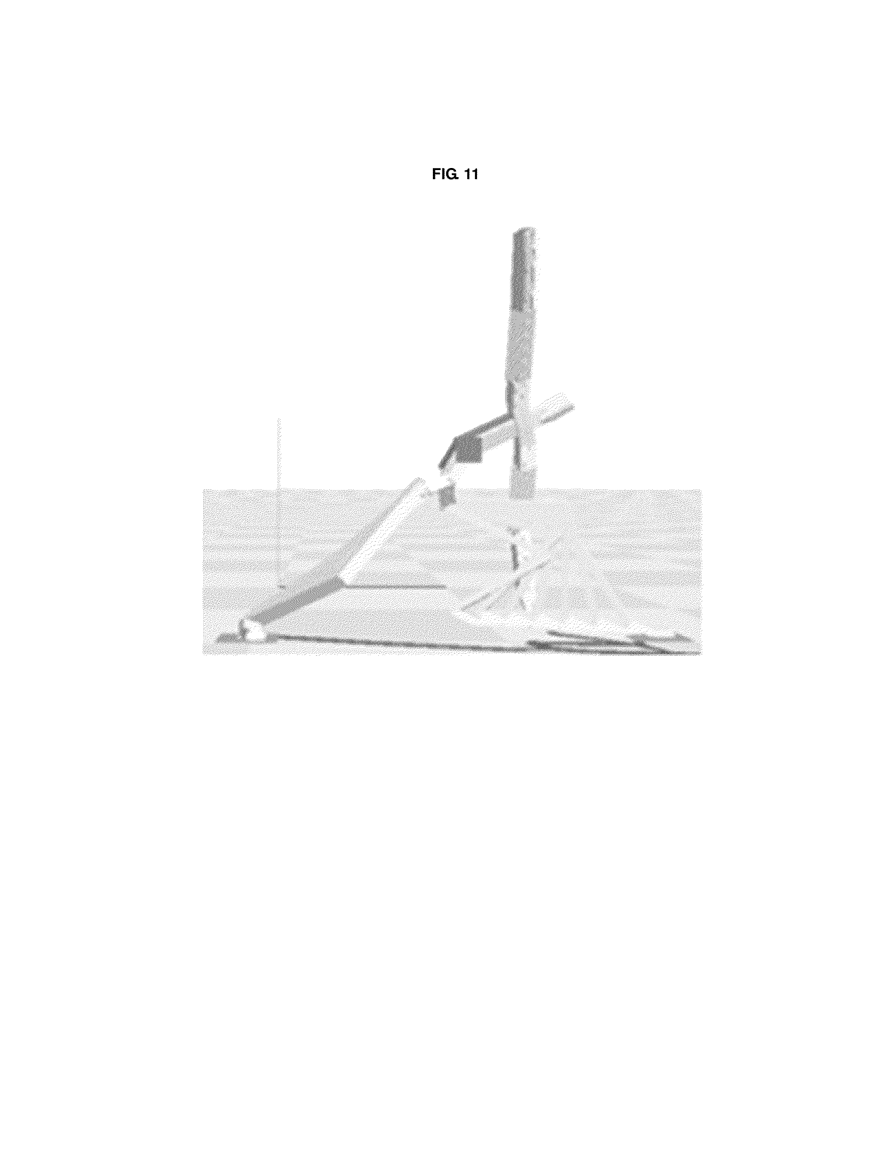

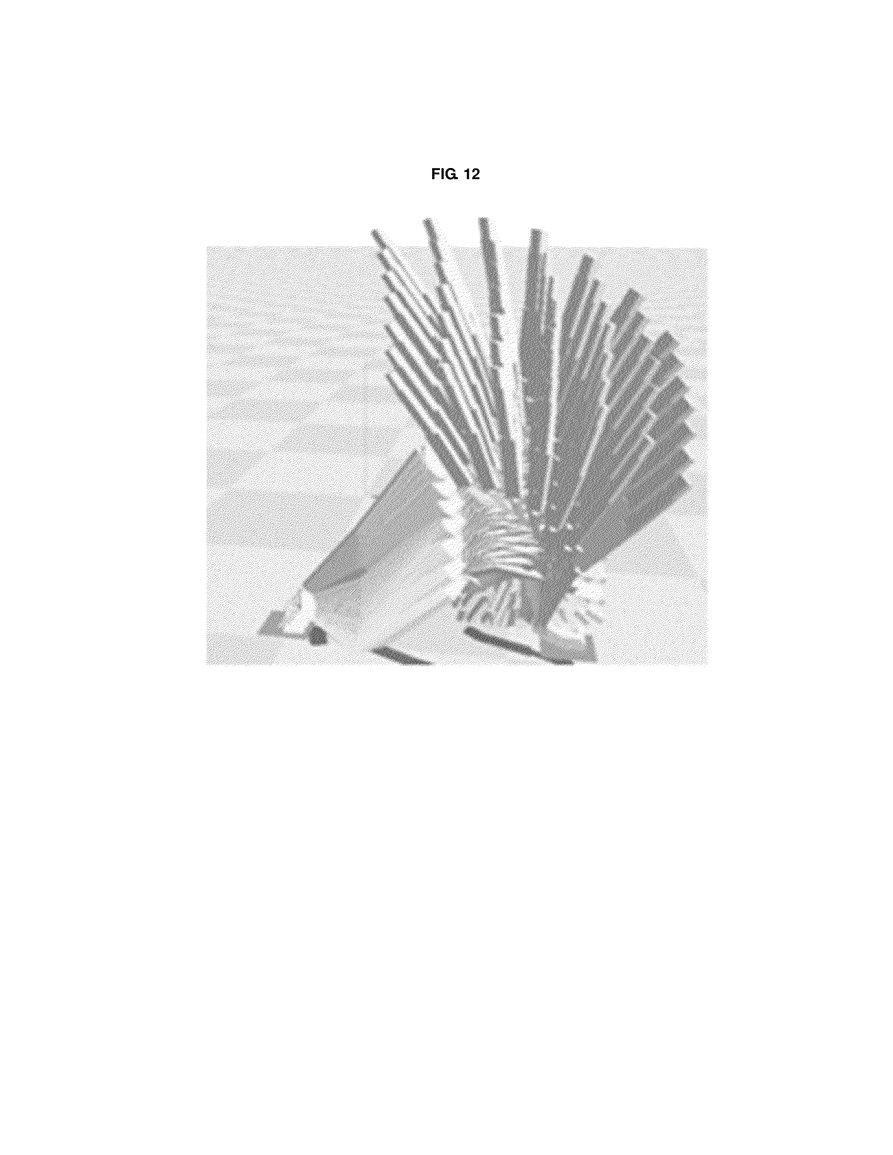

FIG. 8 through FIG. 12 illustrate examples of a new pose created based on a pose resampling parameter according to an embodiment.

As shown in FIG. 8 through FIG. 12, the pose adder according to an aspect may uniformly form a pose space through pose resampling using various parameters.

According to an aspect, through pose resampling, it is possible to configure an independent program that creates a large number of modified poses using motion data having the small number of poses.

For example, when a motion capture such as a yoga operation is performed, it is possible to create various types of motion data in which a corresponding element is variously modified, by reading motion capture data and by manually designating elements such as a change in a height of a body, a change in a gradient, a change in a position of an arm and a foot, and the like with respect to a predetermined yoga operation.

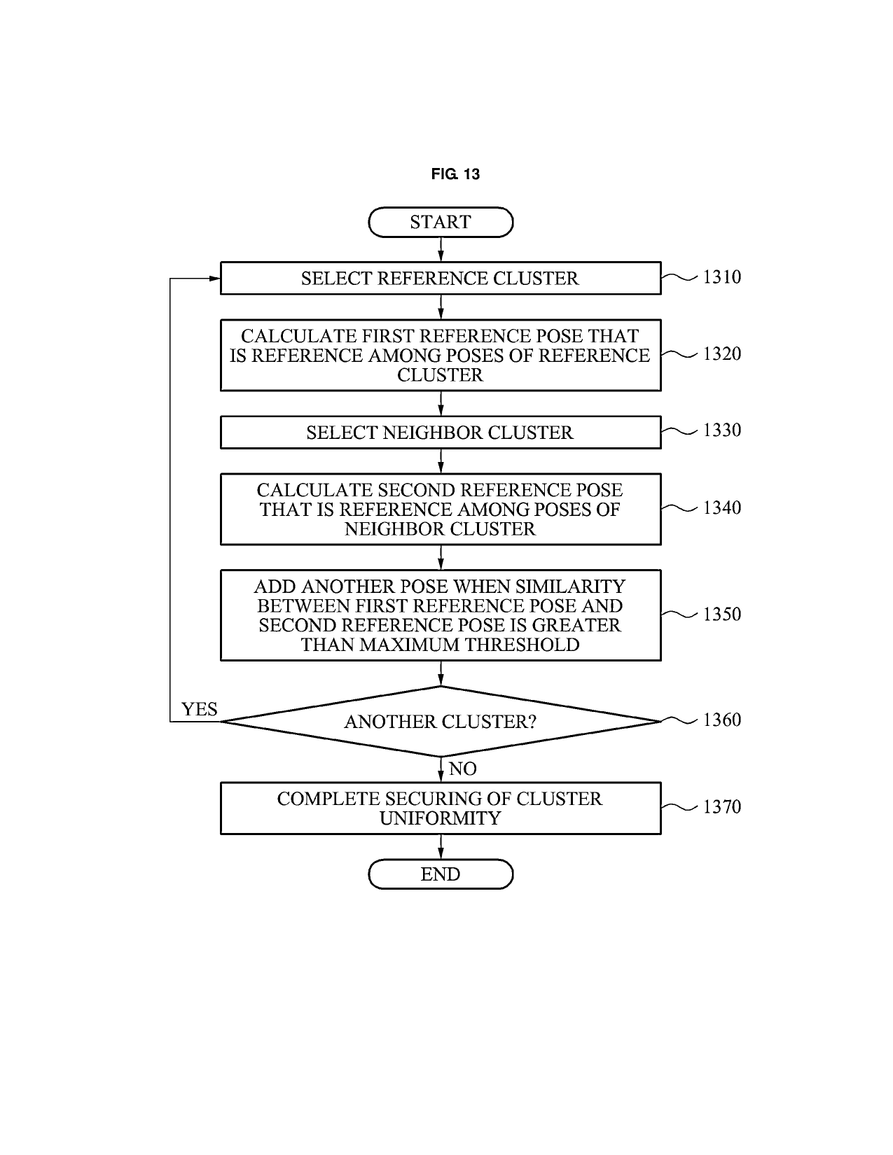

FIG. 13 illustrates a method of securing a pose uniformity between clusters according to an embodiment.

According to an aspect, a pose may be configured as a pose cluster mixture. A pose between pose clusters may sparsely exist in a pose vector space and thus, it is possible to configure an empty pose space to have the same density as an inside of the pose cluster.

Referring to FIG. 13, in operation 1310, the cluster adjustment unit 140 may select a reference cluster using a reference cluster selector.

In operation 1320, the cluster adjustment unit 140 may calculate a first reference pose that is a reference among poses of the reference cluster using a first reference pose calculator.

The reference cluster may be the average cluster. The average cluster may be obtained by calculating the average pose feature vector. A pose having the most similar feature vector to the average pose feature vector may be applied to the average cluster.

In operation 1330, the cluster adjustment unit 140 may select a neighbor cluster using a neighbor cluster selector.

In operation 1340, the cluster adjustment unit 140 may calculate a second reference pose that is a reference among poses of the neighbor cluster using a second reference pose calculator.

When a similarity between the first reference pose and the second reference pose is greater than a predetermined maximum threshold, the cluster adjustment unit 140 may add another pose to the reference cluster using a pose adder in operation 1350.

In operation 1360, the cluster adjustment unit 140 may determine whether there is another cluster. When there is another cluster, the cluster adjustment unit 140 may repeat each module operation. On the contrary, when there is no other cluster, the cluster adjustment unit 140 may complete a configuration so that the number of poses included in each cluster may be uniform in operation 1370.

According to an aspect, by repeating the above process with respect to the entire pose clusters, the inter-cluster pose uniformity may be secured.

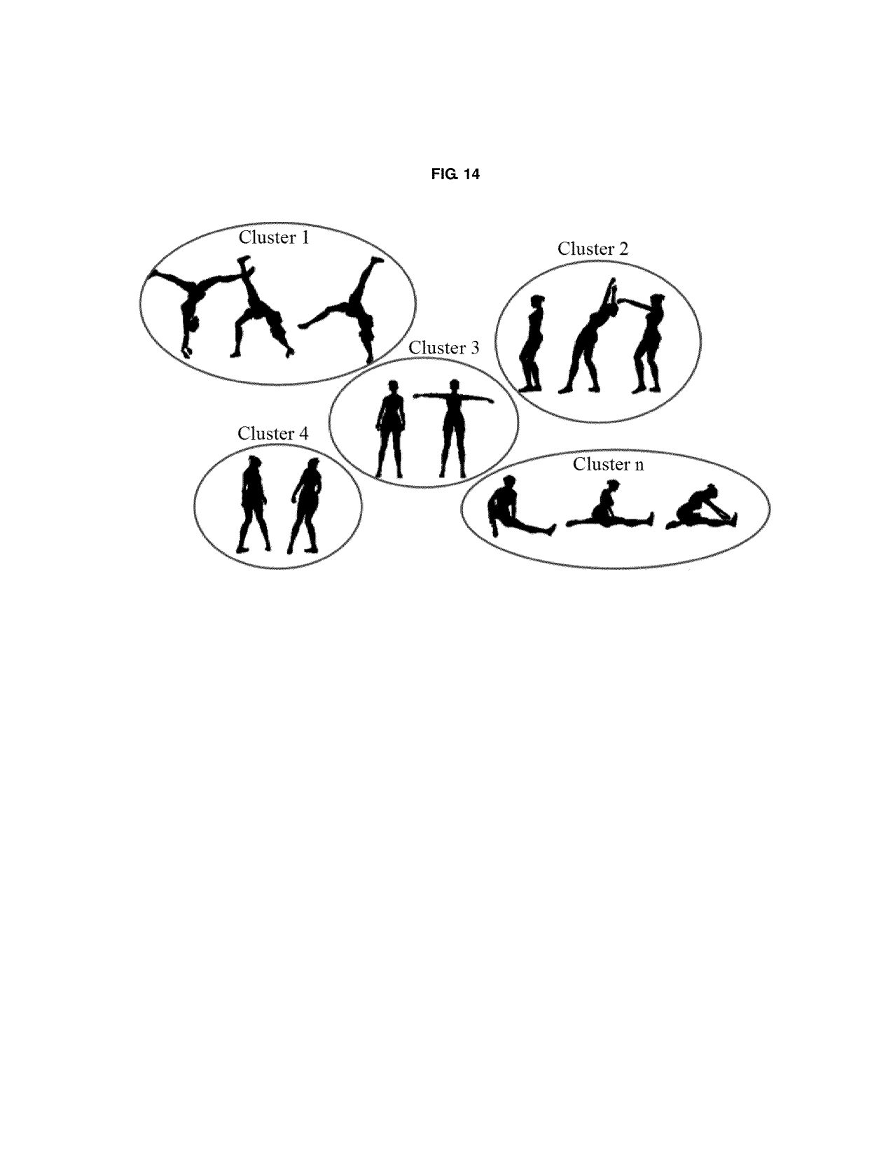

FIG. 14 illustrates an example of a pose cluster according to an embodiment.

According to an embodiment, poses of pose data may be uniformly distributed instead of being densely distributed.

The above-described embodiments may be recorded in non-transitory computer- readable media including program instructions (computer readable instructions) to implement various operations embodied by a computer to cause one or more processors to execute or perform the program instructions. The media may also include, alone or in combination with the program instructions, data files, data structures, and the like. The media and program instructions may be those specially designed and constructed, or they may be of the kind well- known and available to those having skill in the computer software arts. Examples of non- transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. In addition, a non-transitory computer-readable storage medium may be distributed among computer systems connected through a network and computer- readable codes or program instructions may be stored and executed in a decentralized manner. In addition, the computer-readable storage media may also be embodied in at least one application specific integrated circuit (ASIC) or Field Programmable Gate Array (FPGA).

Although a few embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus for creating a pose cluster, the apparatus comprising:
a data receiver to receive pose data about at least one pose;
a feature extractor to extract a feature vector from the pose data;
a cluster classifier to classify, as a single cluster, similar poses from a feature vector space using a similarity measurement;
a cluster adjuster, using at least one processor, to configure the number of poses included in each cluster from the feature vector space to be uniform using an imbalance measurement; and
a pose cluster creator to create the pose cluster by adjusting each cluster to have a predetermined pose density.

2. The apparatus of claim 1, wherein the pose data comprises motion capture data or image data that is created using the motion capture data.

3. The apparatus of claim 1, wherein the feature extractor performs a feature extraction using at least one of a hue moment, a Legendre moment, and a level set.

4. The apparatus of claim 1, wherein the cluster classifier comprises:
a feature vector detector to detect a feature vector of a current pose extracted through feature extraction;
a cluster searcher to search a cluster having a similarity with the feature vector;
a first pose assignor to assign the current pose to the cluster when the cluster having the similarity is present; and
a second pose assignor to create a new cluster and assign the current pose to the new cluster when the cluster having the similarity is absent, and
the cluster classifier completes clustering by repeating each module operation.

5. The apparatus of claim 1, wherein the cluster classifier comprises:
a cluster detector to detect each cluster;
a determining determiner to determine whether a number of pose data within each cluster is greater than a threshold; and
a cluster splitter to split each cluster into at least two portions when the number of pose data within each cluster is greater than the threshold, and the cluster classifier completes clustering by repeating each module operation.

6. The apparatus of claim 1, wherein the cluster classifier comprises:
an average pose calculator to calculate the average pose feature vector of each cluster;
a pose sorter to sort at least one pose based on an inter-pose similarity from the average pose feature vector;
a similarity calculator to calculate a similarity between a current pose and a subsequent pose;
a pose adder to add another pose to each cluster when the similarity between the current pose and the subsequent pose is greater than a predetermined maximum threshold;
a pose eraser to erase poses within each cluster when the similarity between the current pose and the subsequent pose is less than a predetermined minimum threshold; and
a pose determiner to determine a pose within each cluster when the similarity between the current pose and the subsequent pose is less than or equal to the predetermined maximum threshold and is greater than or equal to the predetermined minimum threshold, and
the cluster classifier completes clustering by repeating each module operation.

7. The apparatus of claim 6, wherein the pose adder comprises:
a reference pose setter to set a reference pose;
a parameter setter to set at least one parameter for adding the other pose; and
a new pose adder to add a new pose different from the reference pose based on the at least one parameter.

8. The apparatus of claim 1, wherein the cluster adjuster comprises:
a reference cluster selector to select a reference cluster;
a first reference pose calculator to calculate a first reference pose that is a reference among poses of the reference cluster;
a neighbor cluster selector to select a neighbor cluster;
a second reference pose calculator to calculate a second reference pose that is a reference among poses of the neighbor cluster; and
a pose adder to add another pose to the reference cluster when a similarity between the first reference pose and the second reference pose is greater than a predetermined maximum threshold, and
the cluster adjuster configures the number of poses included in each cluster to be uniform by repeating each module operation.

9. A method of creating a pose cluster, the method comprising:
receiving pose data about at least one pose;
performing feature extraction including a multi-dimensional vector for pose clustering from the pose data;
classifying, as a single cluster, similar poses from a feature vector space using a similarity measurement;
configuring, using at least one processor, the number of poses included in each cluster from the feature vector space to be uniform using an imbalance measurement; and
creating the pose cluster by adjusting each cluster to have a predetermined pose density.

10. The method of claim 9, wherein the classifying comprises:
detecting a feature vector of a current pose extracted by the feature extraction;
searching a cluster having a similarity with the feature vector;
assigning the current pose to the cluster when the cluster having the similarity is present; and
creating a new cluster and assigning the current pose to the new cluster when the cluster having the similarity is absent, and
clustering is completed by repeating each operation.

11. The method of claim 9, wherein the classifying comprises:
detecting each cluster;
determining whether a number of pose data within each cluster is greater than a threshold; and
splitting each cluster into at least two portions when the number of pose data within each cluster is greater than the threshold, and
clustering is completed by repeating each operation.

12. The method of claim 9, wherein the classifying comprises:
calculating the average pose feature vector of each cluster;
sorting at least one pose based on an inter-pose similarity from the average pose feature vector;
calculating a similarity between a current pose and a subsequent pose;
adding another pose to each cluster when the similarity between the current pose and the subsequent pose is greater than a predetermined maximum threshold;
erasing poses within each cluster when the similarity between the current pose and the subsequent pose is less than a predetermined minimum threshold; and
determining a pose within each cluster when the similarity between the current pose and the subsequent pose is less than or equal to the maximum threshold and is greater than or equal to the predetermined minimum threshold, and
clustering is completed by repeating each operation.

13. The method of claim 12, wherein the adding of the other pose comprises:
setting a reference pose;
setting at least one parameter for adding the other pose; and
adding a new pose different from the reference pose based on the at least one parameter.

14. The method of claim 9, wherein the configuring comprises:
selecting a reference cluster;
calculating a first reference pose that is a reference among poses of the reference cluster;
selecting a neighbor cluster;
calculating a second reference pose that is a reference among poses of the neighbor cluster; and
adding another pose to the reference cluster when a similarity between the first reference pose and the second reference pose is greater than a predetermined maximum threshold, and
the number of poses included in each cluster is configured to be uniform by repeating each operation.

15. At least one non-transitory computer-readable medium storing computer readable instructions that control at least one processor to perform the method of claim 9.

16. An apparatus for creating a pose cluster, the apparatus comprising:
a cluster classifier to classify, as a single cluster, similar poses from a feature vector space using a similarity measurement;
a cluster adjustment unit adjuster, using at least one processor, to configure the number of poses included in each cluster from the feature vector space to be uniform using an imbalance measurement; and
a pose cluster creator to create the pose cluster by adjusting each cluster to have a predetermined pose density.

17. A method of creating a pose cluster, the method comprising:
classifying, as a single cluster, similar poses from a feature vector space using a similarity measurement;
configuring, using at least one processor, the number of poses included in each cluster from the feature vector space to be uniform using an imbalance measurement; and
creating the pose cluster by adjusting each cluster to have a predetermined pose density.

18. At least one non-transitory computer-readable medium storing computer readable instructions that control at least one processor to perform the method of claim 17.
